(19) United States
(12) Patent Application Publication
(10) Pub. No.: US 2018/0155219 A1
(43) Pub. Date: Jun. 7, 2018

(54) ELECTROCOAGULATION FLUID TREATMENT SYSTEM

(71) Applicant: Separation Solutions, LLC, Oklahoma City, OK (US)

(72) Inventor: David Earl Wilson, Rhome, TX (US)

(21) Appl. No.: 15/833,716

(22) Filed: Dec. 6, 2017

Related U.S. Application Data
(60) Provisional application No. 62/430,660, filed on Dec. 6, 2016.

(51) Int. Cl. C02F 1/463; C02F 1/461

(52) U.S. Cl. CPC C02F 1/463; C02F 2001/46133; C02F 1/46109

(57) ABSTRACT

A fluid treatment system having an electrocoagulation unit for treating fluid. In one embodiment, the electrocoagulation unit is has a cathode with an electrically conductive cathode tube surrounding a reactor cell. The reactor cell is provided with a non-electrically conductive reactor shell having a plurality of perforations, a plurality of reactor beads disposed within the reactor shell, and an anode rod disposed within the reactor shell in direct contact with at least a portion of some of the reactor beads. When an electrical current is applied to the anode rod and the cathode tube, an electric gradient is created between the anode rod and the cathode tube ionizing contaminants in a fluid passed from the fluid inlet to the fluid outlet.

### CROSS REFERENCE TO RELATED APPLICATIONS

This application claims priority to U.S. Provisional Patent Application No. 62/430,660, filed Dec. 6, 2016, the entire contents of each of which being hereby expressly incorporated herein by reference.

### BACKGROUND

As of 2012, approximately seven billion people are living on planet earth. They use nearly 30% of the world's total accessible and renewable supply of water. By 2025 this value may reach 70%. Yet billions of these same people lack basic water supply services; estimates of 5 million people die each year from water-related diseases (e.g., typhoid and cholera). Water has also become a basis for regional and international conflict.

A great deal of world-wide water use is non-consumptive, which means the water is returned to the environment. Usually this water is contaminated with an array of contaminants, whether it is used for agriculture, domestic consumption, or by industry. The world's water supply problems are further complicated by increasing world population and pollution.

Wastewater treatment, recycling, and reuse is an increasing necessity, as shortages, pollution, and restriction on domestic users and commercial entities by government require that new, economically feasible and readily adaptable technologies be developed for increasing supply.

Industry produces an array of pollutants or contaminants. These include detergents, dyes, pharmaceuticals, petroleum products, oil, grease, heavy metals, biological and non-biological organic products, and food and beverage wastes. These wastewaters are most often discharged directly into the sewer system, rather than treated and recycled for reuse by industry. In many cases, such discharge is a waste of a valuable resource when one considers that technology is available to economically treat and recycle such wastewater streams.

In many parts of the world, especially developing countries, economical and readily adaptable methods to treat water for domestic consumption are severely lacking. Surface waters are often contaminated with untreated human and animal waste, water borne disease organisms, heavy metals and dangerous organic products, including petroleum. Groundwater from wells and boreholes is often contaminated with high concentrations of heavy metals, such as arsenic.

A wide range of wastewater treatment techniques are known. These include biological processes for nitrification, denitrification and phosphorus removal, as well as, a range of physico-chemical processes. The physico-chemical processes include filtration, ion exchange, chemical precipitation, chemical oxidation, carbon adsorption, electrocoagulation, ultrafiltration, reverse osmosis, electrodialysis, and photo-oxidation.

Treatment of wastewater by electrocoagulation (“EC”) has been practiced for most of the twentieth century. It has achieved limited success in most instances. The technology is increasingly being used in Europe for the treatment of industrial wastewater containing heavy metals. In North America the EC process has been employed to treat wastewater from the pulp and paper industry, effluents from the mining industry, and metals processing industry. This technology has been used to treat wastewater containing food stuffs, suspended particles, dyes, petroleum products, animal fats, landfill leachates, solutions of heavy metals, polishing compounds, phosphorus, organic matter, pesticides, and synthetic detergents.

Electrocoagulation is the process that occurs within an electrolytic reactor or cell. The reactor is a cell containing an anode and a cathode. When connected to an external power supply, the anode is oxidized and the cathode is passivated and reduction occurs, producing gases such as hydrogen. In practice, the electrodes are usually parallel metal plates that serve as monopolar electrodes, which may be made of the same or different metal. The electrodes are attached to a DC power supply that allows current and voltage adjustment. Under current flow to the anode, an appropriate metal is oxidized and cations of the metal are released into the flowing wastewater. The anode is referred to as the “sacrificial electrode,” since it is ultimately consumed in the reaction. The ions produced in this reaction neutralize or destabilize contaminants within the wastewater, which allows them to coagulate and precipitate.

Known technology for such systems suffers from a number of disadvantages. These include:
Lack of Adaptability—most systems are designed for single purpose application and are fixed in their design for treating a specific fluid contaminant and/or treating at a specific flow rate.
Lack of Efficiency—most systems lack the capability to efficiently treat a broad spectrum of fluid contaminants.
Complex Operating Systems—many systems are too complex for use by both industry and by individuals in developing countries.
Economically unfeasible—most systems are too costly to attract wide spread use in economically disadvantaged industries as well as developing countries.

To this end, a need exists for a fluid treatment system capable of efficient removal of contaminants that is adaptable to a wide range of applications. It is to such a fluid treatment system that the inventive concepts disclosed herein are directed.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale, or in schematic in the interest of clarity and conciseness. Not every component may be labeled in every drawing. Like reference numerals in the figures may represent and refer to the same or similar element or function. In the drawings:

FIG. 1 is a process and instrumentation diagram for an electrocoagulation fluid treatment system in accordance with one embodiment of the inventive concepts disclosed herein.

FIG. 2 is a cross sectional view of an electrocoagulation unit in accordance with one embodiment of the inventive concepts disclosed herein.

FIG. 3 is an exploded perspective view of a reactor cell of the electrocoagulation unit in accordance with one embodiment of the inventive concepts disclosed herein.

### DETAILED DESCRIPTION OF EXEMPLARY EMBODIMENTS

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

In the following detailed description of embodiments of the inventive concepts, numerous specific details are set forth in order to provide a more thorough understanding of the inventive concepts. However, it will be apparent to one of ordinary skill in the art that the inventive concepts disclosed and claimed herein may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of elements or steps is not necessarily limited to only those elements or steps and may include other elements, steps, or features not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Throughout this disclosure and the claims, the terms “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, or combinations thereof, for example.

The use of the term “at least one” will be understood to include one as well as any quantity more than one, including but not limited to each of, 2, 3, 4, 5, 10, 15, 20, 30, 40, 50, 100, and all integers therebetween. The term “at least one” may extend up to 100 or 1000 or more, depending on the term to which it is attached; in addition, the quantities of 100/1000 are not to be considered limiting, as higher limits may also produce satisfactory results. Singular terms shall include pluralities and plural terms shall include the singular unless indicated otherwise.

The term “or combinations thereof” as used herein refers to all permutations and/or combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment, although the inventive concepts disclosed herein are intended to encompass all combinations and permutations including one or more of the features of the embodiments described herein.

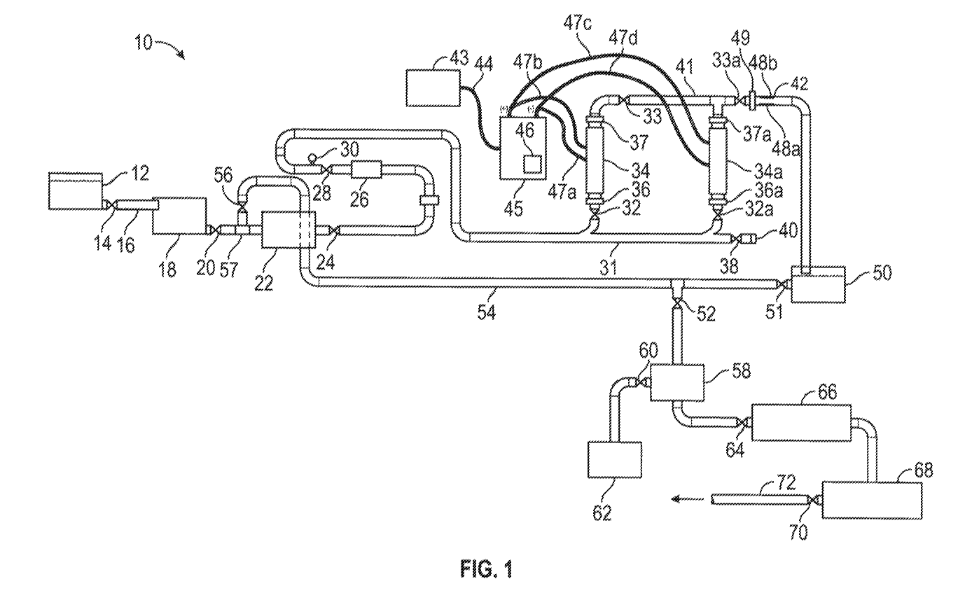

Referring now to the drawings, and in particular FIG. 1, an electrocoagulation fluid treatment system 10 constructed in accordance with the inventive concepts disclosed herein is shown. The electrocoagulation fluid treatment system 10 is designed to enhance coagulation of contaminants in a fluid and decontaminate the treated fluid. As shown in FIG. 1, the electrocoagulation fluid treatment system 10 is provided with a fluid holding tank 12, a holding tank control valve 14, fluid flow lines 16, a separation filter 18, a separation filter control valve 20, a pump 22, a pump control valve 24, a fluid flow meter 26, a fluid flow meter control valve 28, a pressure gauge 30, an inlet manifold 31, electrocoagulation unit control valves 32, 32a, 33, and 33a, at least one electrocoagulation unit 34 and 34a, couplers 36, 36a, 37 and 37a, a cleanout control valve 38, a cleanout 40, outlet manifold 41, a magnetic treatment unit 42, a generator 43, cables 44, a control unit 45, control systems 46, cables 47a, 47b, 47c, and 47d, permanent magnets 48a and 48b, a sensor array 49, a settlement tank 50, a settlement tank control valve 51, a recirculation line control valve 52, a recirculation flow line 54, a recirculation control valve 56, a recirculation T 57, a filter 58, a backwash tank control valve 60, a backwash tank 62, a treated fluid tank control valve 64, a treated fluid tank 66, a treated fluid storage tank 68, a supply line control valve 70, and a treated fluid supply line 72.

In operation of the electrocoagulation fluid treatment system 10, fluid is moved from the fluid holding tank 12 through the holding tank control valve 14 via the fluid flow line 16 to the separation filter 18 where the fluid is treated to remove larger debris and to separate immiscible liquids of different densities such as oil and water, for instance.

The fluid then passes from the separation filter 18 through the separation filter control valve 20 and fluid flow line 16 to the pump 22. The pump 22 then moves the fluid via the fluid flow line 16 through the fluid flow meter 26 and the pressure gauge 30. A fluid flow rate is checked by the fluid flow meter 26 and a fluid pressure is checked by the pressure gauge 30. The flow rate at which the fluid is pumped is dictated by the size of the electrocoagulation fluid treatment system 10 and the fluid that is being treated. Flow rates may be between 10 and 1000 gallons per minute (gpm).

The fluid then passes through inlet manifold 31 where the fluid is distributed through the electrocoagulation unit control valves 32, 32a, 33, and 33a, the at least one electrocoagulation unit 34 and 34a, the couplers 36, 36a, 37, and 37a, and out through the outlet manifold 41. The fluid receives electrochemical treatment in the at least one electrocoagulation unit 34 and 34a which will be described in detail later.

In one embodiment of the electrocoagulation fluid treatment system 10, a fluid flow rate through the at least one electrocoagulation unit 34 and 34a is controlled by the electrocoagulation unit control valves 32 and 32a. This enables the electrocoagulation fluid treatment system 10 to divide the total fluid flow rate between multiple electrocoagulation units 34 and 34a. Each electrocoagulation unit 34 and 34a may be configured to treat between 5 gpm and 100 gpm. For the sake of illustration, the electrocoagulation units 34 and 34a shown in FIG. 1 will be described as being configured to treat 20 gallons per minute. In such an embodiment, a total flow rate of 40 gpm is achieved while providing redundancy and ease of service of the electrocoagulation units 34 and 34a.

When it is necessary to service one of the electrocoagulation units 34 or 34a (for the sake of illustration we will use electrocoagulation unit 34), the electrocoagulation unit control valves 32 and 33 are closed and the electrocoagulation unit 34 is removed by uncoupling the couplers 36 and 37. Once service is completed, the electrocoagulation unit 34 is re-attached via couplers 36 and 37 and the electrocoagulation unit control valves 32 and 33 are opened restoring fluid flow to electrocoagulation unit 34. While this service is being completed, electrocoagulation unit 34a continues to operate. In this manner, the electrocoagulation fluid treatment system 10 may be continually operated even when service of one of the electrocoagulation units 34 or 34a is necessary.

When configured in such an embodiment, the electrocoagulation fluid treatment system 10 is scalable and allows virtually any desired total flow rate to be achieved by adding or taking away electrocoagulation units 34. For example, using a total fluid flow rate of 90 gpm and a fluid flow rate of 20 gpm per electrocoagulation unit 34, we can calculate the number of electrocoagulation units 34 necessary by dividing the desired fluid flow rate (90) by the fluid flow rate per electrocoagulation unit 34 (20) which results in 90÷20=4.5. Rounding up to the next whole number results in an electrocoagulation fluid treatment system 10 having a total of five (5) electrocoagulation units 34 to achieve the desired fluid flow rate of 90 gpm.

In addition, redundant electrocoagulation units 34 may be added to an electrocoagulation fluid treatment system 10 to constantly provide for the desired fluid flow rate, even while one or more of the electrocoagulation units 34 is being serviced or is inoperable. Using the example above, adding another electrocoagulation unit 34 to the electrocoagulation fluid treatment system 10 would allow for the desired 90 gpm fluid flow rate even while one of the electrocoagulation units 34 was being serviced.

It should be noted that the fluid flow rate through each of the electrocoagulation units 34 may vary, depending on the particular application, and the 20 gpm figure has been provided by way of illustration only. Other fluid flow rates may be achieved by scaling the electrocoagulation unit 34 as will be explained later.

The control unit 45 is further provided with control systems 46 which are configured to continuously monitor each electrocoagulation unit 34 and 34a for voltage, current, fluid flow, conductivity, and temperature using information supplied by sensor array 49. Electrical power in the form of direct current (d/c) is supplied to the at least one electrocoagulation unit 34 and 34a from the control unit 45 which is configured to convert alternating current (a/c) supplied by the generator 43 to d/c. The voltage supplied to the at least one electrocoagulation unit 34 and 34a may vary, depending on the particular application and signals provided by control systems 46, from substantially 1.6 volts to substantially 50 volts. The amperage supplied to the at least one electrocoagulation unit 34 and 34a may vary, depending on the particular application and signals provided by control systems 46, from substantially 2 amps to substantially 50 amps.

After the fluid has been electrochemically treated in the electrocoagulation units 34 and 34a, the fluid passes through the outlet manifold 41 and through a magnetic field provided by the magnetic treatment unit 42. The magnetic treatment unit 42 provides a magnetic field strength in the range of 2000 to 5000 gauss. As determined during field studies, in some embodiments passing the electrochemically treated fluid through the magnetic field increases the coagulation and precipitation rate by 2 to 4 times when compared to fluid treated electrochemically alone.

As illustrated in FIG. 1, the magnetic treatment unit 42 is comprised of permanent magnets 48a and 48b, such as neodymium, samarium-cobalt, or alnico. However, it should be noted that in some embodiments of the electrocoagulation fluid treatment system 10 the magnetic treatment unit 42 may be comprised of at least one electromagnet (not shown) providing an electromagnetic field having a field strength of 2000 to 7500 gauss.

The electrochemically and magnetically treated fluid is then passed to settlement tank 50 where the fluid is treated by conventional flocculation and sedimentation methods and settleable solids flocculate and precipitate out of the fluid. Settleable solids, which accumulate as tank bottoms, are periodically removed from the settlement tank 50 by a pneumatic tanker truck, for instance, and disposed off-site.

Upon completion of movement through the settlement tank 50, the fluid passes through the settlement tank control valve 51 and may be passed through the recirculation line control valve 52 to the filter 58, or, the fluid may be recirculated through the electrocoagulation unit 34 and 34a and the magnetic treatment unit 42 by directing the fluid through the recirculation flow line 54 to the recirculation T 57 via the recirculation control valve 56. In this manner, the fluid may receive additional electrochemical and magnetic treatment as necessary.

Fluid that does not need further electrochemical and magnetic treatment is passed through filter 58 to remove any remaining particles larger than a predetermined size and to biologically decontaminate the fluid.

Filtered fluid is then passed through the treated fluid tank control valve 64 to the treated fluid tank 66 and the treated fluid storage tank 68. Release of the fluid to the treated fluid supply line 72 is controlled by the supply line control valve 70.

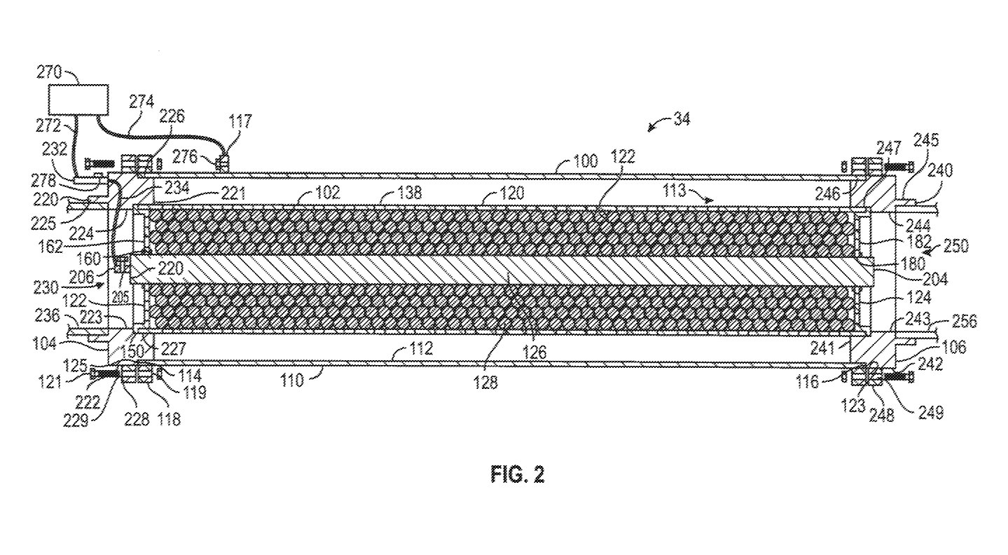

Referring now to FIG. 2, a cross sectional view of an electrocoagulation unit 34 is shown in accordance with one embodiment of the inventive concepts disclosed herein. Broadly, the electrocoagulation unit 34 is provided with a cathode 100, a reactor cell 102, a first end cap 104, a second end cap 106, a control unit 270, and cables 272 and 274.

In the embodiment shown in FIG. 2, the cathode 100 is cylindrically shaped and formed of a suitable material such as, for instance, iron, aluminum, titanium, stainless steel, or graphite and is provided having a predetermined length. The cathode 100 has an outer surface 110 with a predetermined circumference, an inner surface 112 defining an aperture 113 having a predetermined diameter, a first end 114, a second end 116, an electrical connector 117 operably connected to the outer surface 110, and a plurality of securing members 118 (only one of which is designated in FIG. 2) secured to the outer surface 110. The securing members 118 are provided with bolt holes 119 (only one of which is designated in FIG. 2) which extend through the securing members 118 and which are adapted to slidably receive connecting members, such as bolts 121 (only one of which is designated in FIG. 2), or other suitable connecting members for securing the cathode 100 to the first and second end caps 104 and 106. Sealing members, such as gaskets 123 and 125, may be positioned between the cathode 100 and the first and second end caps 104 and 106 to provide a fluid tight seal between the cathode 100 and the first and second end caps 104 and 106 when the cathode 100 is secured to the first and second end caps 104 and 106.

In some embodiments, the cathode 100 may further be provided having a protective covering (not shown) configured to be deployed over the outer surface 110 covering the cathode 100 from the first end 114 to the second end 116.

For the sake of illustration, the cathode 100 will be described herein as being twelve (12) inches in length from the first end 114 to the second end 116 with the aperture 113 diameter being three (3) inches. However, it should be understood that in other embodiments the cathode 100 may be provided having different physical dimensions.

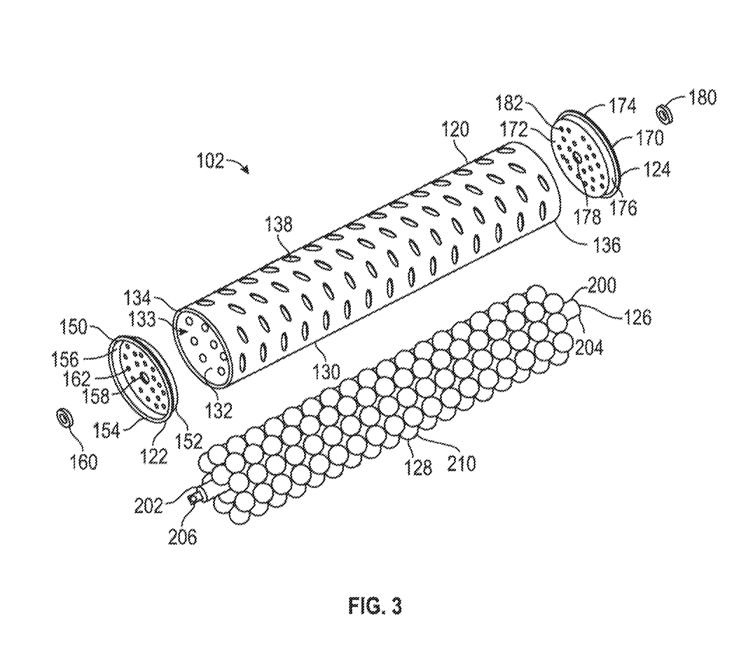

Referring now to FIGS. 2 and 3, the reactor cell 102 is provided with a reactor shell 120, a first reactor shell end cap 122, a second reactor shell end cap 124, an anode rod 126, and a plurality of reactor beads 128 (only one of which is designated in FIGS. 2 and 3).

In the embodiments shown in FIGS. 2 and 3, the reactor shell 120 is cylindrical in shape and is formed of a suitable non-electrically conductive material such as, for instance, poly-vinyl chloride (PVC), or acrylonitrile butadiene styrene (ABS), and is provided having a predetermined length, an outer surface 130 having a predetermined circumference, an inner surface 132 defining an aperture 133 having a predetermined diameter, a first end 134, a second end 136, and a plurality of perforations 138 (only one of which is designated in FIGS. 2 and 3) extending from the outer surface 130 to the inner surface 132 in a spaced apart relation at predetermined intervals.

For the sake of illustration, the reactor shell 120 will be described herein as being twelve (12) inches in length from the first end 134 to the second end 136 with the aperture 133 diameter being two (2) inches. However, it should be understood that the reactor shell 120 may be provided having different physical dimensions in other embodiments.

The first and second reactor shell end caps 122 and 124 are substantially the same, therefore, in the interest of brevity, the first and second reactor shell end caps 122 and 124 will be described together. The first and second reactor shell end caps 122 and 124 are formed of a suitable non-electrically conductive material such as, for instance, poly-vinyl chloride (PVC), or acrylonitrile butadiene styrene (ABS), and are provided with a first surface 150 and 170, a second surface 152 and 172, a seating shoulder 154 and 174, a downward extending seal section 156 and 176, an anode rod receiving bore 158 and 178, an anode rod sealing grommet 160 and 180, and a plurality of perforations 162 and 182 (only one of which is designated in FIGS. 2 and 3) extending from the first surface 150 and 170 to the second surface 152 and 172 in a spaced apart relation at predetermined intervals.

The first and second reactor shell end caps 122 and 124 are dimensioned such that second surface 152 and 172 of the downward extending seal section 156 and 176 is substantially the same diameter as the aperture 133 of the reactor shell 120. As shown in FIG. 2, the first and second reactor shell end caps 122 and 124 may be removably deployed at least partially within the aperture 133 of the reactor shell 120 with the second surface 152 and 172 of the downward extending seal section 156 and 176 in fluid communication with the inner surface 132 of the reactor shell 120. The seating shoulder 154 and 174 of the first and second reactor shell end caps 122 and 124 is dimensioned to facilitate seating of the first and second reactor shell end caps 122 and 124 to the first and second end 134 and 136, respectively, of the reactor shell 120 such that the seating shoulders 154 and 174 are supportingly disposed in fluid contact with the first and second end 134 and 136 respectively of the reactor shell 120 as shown in FIG. 2.

The anode rod 126 is formed of a suitable material such as, for instance, iron, aluminum, titanium, stainless steel, or graphite and is provided having a predetermined length, an outer surface 200 having a predetermined diameter, a first end 202, a second end 204, and an electrical connector 206 operably connected to the first end 202. The anode rod 126 may be removably deployed at least partially within the aperture 133 of the reactor shell 120 with the first end 202 extending a predetermined distance from the first end 134 and the second end 204 extending a predetermined distance from the second end 136 of the reactor shell 120. The anode rod 126 may be secured in place with the outer surface 200 in fluid communication with the anode rod sealing grommets 160 and 180 of the first and second end caps 122 and 124, respectively.

For the sake of illustration, the anode rod 126 will be described herein as being thirteen (13) inches in length from the first end 202 to the second end 204 with the outer surface 200 diameter being one half (½) inch. However, it should be understood that the anode rod 126 may be provided having different physical dimensions in other embodiments.

The reactor beads 128 are formed of a suitable material such as, for instance, iron, aluminum, titanium, stainless steel, or graphite and are provided with an outer surface 210 and a predetermined diameter. For the sake of illustration, the reactor beads 128 will be described herein as having a diameter of thirteen-sixty-fourths ( 13/64) of an inch. However, it should be understood that in other embodiments of the electrocoagulation unit 34 the reactor beads 128 may be provided having a different diameter.

As shown in FIG. 2, the reactor beads 128 are disposed within the aperture 133 of the reactor shell 120 surrounding the anode rod 126. At least a portion of the outer surface 210 of at least one of the reactor beads 128 will be in direct contact with at least a portion of the outer surface 200 of the anode rod 126. The reactor beads 128 are secured within the aperture 133 of the reactor shell 120 by the first and second reactor cell end caps 122 and 124.

The plurality of perforations 138, 162, and 182 are dimensioned to allow fluid flow while preventing the reactor beads 128 from passing through the plurality of perforations 138, 162, and 182. For the sake of illustration, the plurality of perforations 138, 162, and 182 will be described herein as having a diameter of five-thirty-seconds ( 5/32) of an inch. However, it should be noted that in other embodiments the plurality of perforations 138, 162, and 182 may be provided with different dimensions.

In one embodiment of the electrocoagulation unit 34, the plurality of perforations 138 of the reactor shell 120 are substantially circular in shape and are spaced apart by a predetermined distance with a center of the plurality of perforations 138 aligned in a row along a first axis (not shown) which extends along the length of the reactor shell 120 from the first end 114 to the second end 116. In such an embodiment where the diameter of the plurality of perforations 138 is five-thirty-seconds ( 5/32) of an inch, the plurality of perforations 138 are spaced apart by one-half (½) inch when measured from the center of one perforation 138 to the center of the adjacent perforation 138 in the same row. A plurality of rows are spaced apart by one-half (½) inch when measured from the first axis of one row to the first axis of the adjacent row. The plurality of perforations 138 in one row are offset from the plurality of perforations 138 in the adjacent rows by one-quarter (¼) inch as shown in FIG. 3.

In the embodiment shown in FIG. 2, the first and second end caps 104 and 106 are substantially the same. Therefore, in the interest of brevity the features of the first and second end caps 104 and 106 will be described together with any differences noted for clarity. The first and second end caps 104 and 106 are formed of a suitable non-electrically conductive material such as, for instance, poly-vinyl chloride (PVC), or acrylonitrile butadiene styrene (ABS), and are provided with a first end 220 and 240, a second end 221 and 241, an outer surface 222 and 242, an inner surface 223 and 243, a seating shoulder 224 and 244, a supply line connection portion 225 and 245, a cathode connection portion 226 and 246, a reactor cell connection portion 227 and 247, securing members 228 and 248 (only one of which is labeled in FIG. 2), bolt holes 229 and 249 (only one of which is labeled in FIG. 2), and a fluid port 230 and 250. The first end cap 104 is further provided with an electrical connector 232, and a wire 234 operably connected to the electrical connector 232.

The seating shoulders 224 and 244 are formed on the inner surface 223 and 243 and extend a predetermined distance from the first end 220 and 240 and the second end 221 and 241. The supply line connection portions 225 and 245 are formed on the inner surfaces 223 and 243 of the first and second end caps 104 and 106 extending from the first end 220 and 240 to the seating shoulder 224 and 244 and are dimensioned to receive supply lines 236 and 256.

The reactor cell connection portions 227 and 247 are formed on the inner surfaces 223 and 243 of the first and second end caps 104 and 106 extending from the second ends 221 and 241 to the seating shoulder 224 and 244 and are dimensioned to receive the reactor cell 102. The reactor cell connection portions 227 and 247 of the first and second end caps 104 and 106 are dimensioned to facilitate seating of the first and second reactor shell end caps 122 and 124 to the seating shoulders 224 and 244 such that the first and second end caps 104 and 106 of the reactor shell 120 are supportingly disposed in fluid contact with the seating shoulders 224 and 244 of the first and second end caps 104 and 106.

The cathode connection portions 226 and 246 are formed on the outer surfaces 222 and 242 of the first and second end caps 104 and 106 extending a predetermined distance from the second ends 221 and 241 and are dimensioned to receive the cathode 100.

The supply line connection portions 225 and 245 of the first and second end caps 104 and 106 are configured to facilitate a sealing connection to supply lines 236 and 256 to permit the flow of fluid through the electrocoagulation unit 34. In the embodiment shown in FIG. 2, the supply lines 236 and 256 are PVC and are secured in the supply line connection portions 225 and 245 using PVC cement. However, it should be noted that the supply lines 236 and 256 may be configured to facilitate a sealing connection to supply lines 236 and 256 by other suitable connector means such as, for instance, the couplers 36, 36a, 37, and 37a shown in FIG. 1.

The securing members 228 and 248 are provided with bolt holes 229 and 249 which extend through the securing members 228 and 248 and are designed to slidably receive connecting members, such as bolts 121, or other suitable connecting members for securing the securing members 228 and 248 of the first and second end caps 104 and 106 to the securing members 118 of the cathode 100. Sealing members, such as gaskets 123 and 125, may be positioned between the first and second end caps 104 and 106 and the first and second ends 114 and 116 of the cathode to provide a fluid tight seal therebetween.

The electrical connector 232 is secured to the first end cap 104 and operably connected to the wire 234 which is at least partially disposed within the first end cap 104. A predetermined length of the wire 234 extends through the inner surface 223 of the first end cap 104 and is formed to facilitate a secure, electrically conductive connection between the electrical connector 232 of the first end cap 104 and the electrical connector 206 of the anode rod 126. The wire 234 may be removably secured to the electrical connector 206 with a connecting member, such as bolt 205, or other suitable connecting member for facilitating the secure, electrically conductive connection between the wire 234 of the first end cap 104 and the electrical connector 206 of the anode rod 126.

The control unit 270 is operably connected to a power supply such as, for instance, generator 43 (FIG. 1) and is configured to regulate the power level and the type of power (i.e. converting a/c to d/c) supplied to the electrocoagulation unit 34. The control unit 270 supplies a positive electrical charge to electrical connector 232 of the first end cap 104 via cable 272 and a negative electrical charge to electrical connector 117 of the cathode 100 via cable 274. The cables 272 and 274 are configured to facilitate a secure, electrically conductive connection between the cables 272 and 274 and the electrical connectors 232 and 117 and are secured to electrical connectors 232 and 117 with connecting members such as bolts 278 and 276 respectively, or other suitable connecting members. The positive electrical charge is further supplied to the anode rod 126 by the electrical connector 232 and wire 234.

In operation of one embodiment of the electrocoagulation unit 34, electrical power is supplied by a power source such as, for instance, the generator 43 (FIG. 1) or other suitable power source to the control unit 270 which regulates the power supplied to the electrocoagulation unit 34. Fluid is directed to and from the electrocoagulation unit 34 by supply lines 236 and 256. Fluid enters the electrocoagulation unit 34 through the fluid port 230 of the first end cap 104 and is directed to pass through the plurality of perforations 162 of the first reactor shell end cap 122 into the reactor cell 102. Once in the reactor cell 102, the fluid passes freely over and around the outer surface 210 of the reactor beads 128, through the plurality of perforations 138 of the reactor shell 120 into the aperture 113 of the cathode 100, and back into the reactor cell 102 through the plurality of perforations 138. The reactor beads 128 are supplied with a positive electrical charge by the anode rod 126 and the cathode 100 is supplied with a negative electrical charge. In such an embodiment, the reactor beads 128 are sacrificial anodes which produce metal ions that act as coagulant agents in the fluid. These ions react with hydroxyl ions, also produced within the fluid. These ions react to form insoluble precipitates of ferrous and ferric hydroxide. Additional reactions occur to form other insoluble species, including hydroxides of various cations and those of heavy metals. Cathodic reactions include the production of hydrogen and chlorine gases. A portion of the chlorine gas may ionize to form the hypochlorite ion which serves as a disinfectant. The treated fluid exits the electrocoagulation unit 34 by first passing through the plurality of perforations 182 in the second reactor cell end cap 124 and then moving through the fluid port 250.

The electrocoagulation unit 34 may be scaled to facilitate different flow rates as long as the surface area ratio between the cathode 100 and the sacrificial anode reactor beads 128 is maintained.

The fluid to be treated may include municipal sewage; animal feedlot and dairy wastewater; industrial effluents contaminated with heavy metals, paint, synthetic detergents, animal slaughter residue, petroleum, or food and beverage products; fracture water produced during oil and gas drilling; leachate from landfills; runoff water from sedimentation basins; car and truck wash wastewater; and contaminated ground water from wells and boreholes.

From the above description, it is clear that the present inventive concept is well adapted to carry out the objects and to attain the advantages mentioned herein as well as those inherent in the invention. While exemplary embodiments of the invention have been described for purposes of this disclosure, it will be understood that numerous changes may be made which will readily suggest themselves to those skilled in the art and which are accomplished within the spirit of the inventive concepts disclosed and claimed herein.

What is claimed is:

1. An electrocoagulation unit, comprising:
a cathode comprising a first end cap, a second end cap, and an electrically conductive cathode tube sealably secured between the first end cap and the second end cap; and
a reactor cell disposed in the cathode tube, the reactor cell comprising:
a non-electrically conductive reactor shell having a plurality of perforations;
a plurality of reactor beads disposed within the reactor shell;
an anode rod disposed within the reactor shell in direct contact with at least a portion of some of the reactor beads;
a first shell end cap having a plurality of perforations and secured to one end of the reactor shell to define a fluid inlet into the reactor cell; and
a second shell end cap having a plurality of perforations and secured to an opposing end of the reactor shell so as to define a fluid outlet from the reactor cell and to secure the reactor beads and the anode rod in the reactor shell.

2. The electrocoagulation unit of claim 1, wherein the reactor beads surround the anode rod.

3. The electrocoagulation unit of claim 2, wherein the anode rod is centrally disposed within the reactor shell.

4. The electrocoagulation unit of claim 1, wherein each of the reactor beads has an outer diameter, and wherein each of the perforations of the reactor shell has a diameter that is less than the outer diameter of the reactor beads.

5. The electrocoagulation unit of claim 1, wherein at least one of the first end cap and the second end cap of the cathode is removably secured to the cathode tube.

6. The electrocoagulation unit of claim 5, wherein each of the first end cap and the second end cap of the cathode has a supply line connection portion defining an aperture, and wherein the reactor cell is removably disposed in the cathode with the fluid inlet and the fluid outlet of the reactor cell in fluid communication with the supply line connection portion of the first end cap and the second end cap, respectively.

7. The electrocoagulation unit of claim 1, wherein the reactor beads are formed of a material selected from the group consisting of iron, aluminum, titanium, and stainless steel.

8. The electrocoagulation unit of claim 1, wherein the first shell end cap and the second shell end cap are non-electrically conductive.

9. A fluid treatment system, comprising:
an electrocoagulation unit, comprising:
a cathode comprising a first end cap, a second end cap, and an electrically conductive cathode tube sealably secured between the first end cap and the second end cap;
a reactor cell disposed in the cathode tube, the reactor cell comprising:
a non-electrically conductive reactor shell having a plurality of perforations;
a plurality of reactor beads disposed within the reactor shell;
an anode rod disposed within the reactor shell in direct contact with at least a portion of some of the reactor beads;
a first shell end cap having a plurality of perforations and secured to one end of the reactor shell to define a fluid inlet into the reactor cell; and
a second shell end cap having a plurality of perforations and secured to an opposing end of the reactor shell so as to define a fluid outlet from the reactor cell and to secure the reactor beads and the anode rod in the reactor shell; and
a power source electrically connected to the cathode tube and the anode rod of the electrocoagulation unit,
wherein when the power source applies an electric current to the anode rod and the cathode tube, an electric gradient is created between the anode rod and the cathode tube ionizing contaminants in a fluid passed from the fluid inlet to the fluid outlet.

10. The electrocoagulation unit of claim 9, wherein the reactor beads surround the anode rod.

11. The fluid treatment system of claim 10, wherein the anode rod is centrally disposed within the reactor shell.

12. The fluid treatment system of claim 9, wherein each of the reactor beads has an outer diameter, and wherein each of the perforations of the reactor shell has a diameter that is less than the outer diameter of the reactor beads.

13. The fluid treatment system of claim 9, wherein at least one of the first end cap and the second end cap of the cathode is removably secured to the cathode tube.

14. The fluid treatment system of claim 13, wherein each of the first end cap and the second end cap of the cathode has a supply line connection portion defining an aperture, and wherein the reactor cell is removably disposed in the cathode with the fluid inlet and the fluid outlet of the reactor cell in fluid communication with the supply line connection portion of the first end cap and the second end cap, respectively.

15. The fluid treatment system of claim 9, wherein the reactor beads are formed of a material selected from the group consisting of iron, aluminum, titanium, and stainless steel.

16. The fluid treatment system of claim 9, wherein the first shell end cap and the second shell end cap of the electrocoagulation unit are non-electrically conductive.

17. A fluid treatment system, comprising:
a source of fluid;
a plurality of electrocoagulation units in fluid communication with the source of fluid with the electrocoagulation units fluidly connected in parallel, each of the electrocoagulation units comprising:
a cathode comprising a first end cap, a second end cap, and an electrically conductive cathode tube sealably secured between the first end cap and the second end cap; and
a reactor cell disposed in the cathode tube, the reactor cell comprising:
a non-electrically conductive reactor shell having a plurality of perforations;
a plurality of reactor beads disposed within the reactor shell;
an anode rod disposed within the reactor shell in direct contact with at least a portion of some of the reactor beads;
a first shell end cap having a plurality of perforations and secured to one end of the reactor shell to define a fluid inlet into the reactor cell; and
a second shell end cap having a plurality of perforations and secured to an opposing end of the reactor shell so as to define a fluid outlet from the reactor cell and to secure the reactor beads and the anode rod in the reactor shell;
a power source electrically connected to the cathode tube and the anode rod,
wherein when the power source applies an electric current to the anode rod and the cathode tube, an electric gradient is created between the anode rod and the cathode tube ionizing contaminants in a fluid passed from the fluid inlet to the fluid outlet.

18. The fluid treatment system of claim 17, wherein each of the plurality of electrocoagulation units are removably connected to the fluid source.

19. The electrocoagulation unit of claim 17, wherein the reactor beads surround the anode rod.

20. The fluid treatment system of claim 19, wherein the anode rod is centrally disposed within the reactor shell.

21. The fluid treatment system of claim 17, wherein each of the reactor beads has an outer diameter, and wherein each of the perforations of the reactor shell have a diameter that is less than an outer diameter of the reactor beads.

22. The fluid treatment system of claim 17, wherein the reactor beads are formed of a material selected from the group consisting of iron, aluminum, titanium, and stainless steel.

23. The fluid treatment system of claim 17, wherein the first shell end cap and the second shell end cap of the electrocoagulation unit are non-electrically conductive.
